(19) United States
(12) Patent Application Publication
(10) Pub. No.: US 2026/0113115 A1
(43) Pub. Date: Apr. 23, 2026

(54) OPTICAL TERMINAL, OPTICAL SYSTEM AND METHOD FOR FREE-SPACE OPTICAL COMMUNICATION

(71) Applicant: Airbus SAS, BLAGNAC (FR)

(72) Inventors: Alberto COMIN, BLAGNAC (FR); Nunzio SCIAMMETTA, BLAGNAC (FR)

(21) Appl. No.: 19/360,249

(22) Filed: Oct. 16, 2025

(30) Foreign Application Priority Data
Oct. 18, 2024 (DE) 102024130305.0

(51) Int. Cl. H04B 10/11; H04B 10/50; H04B 10/70

(52) U.S. Cl. CPC H04B 10/11; H04B 10/503; H04B 10/70

(57) ABSTRACT

A terminal for free-space optical communication, with a transmitting part generating first laser signals with a phase and/or amplitude encoded for forming a first laser beam, a beam combiner part forming the first laser beam by coherently combining, transmitting the first laser beam towards a target through an atmospheric channel, receiving a second laser beam having an altered second spatial beam pattern, and spatially dividing the second laser beam into a plurality of second laser signals, a receiving part configured to detect a phase and/or amplitude of second laser signals for determining a altered second spatial beam pattern, and a controller for determining the altered second spatial beam pattern by analyzing the second laser signals, estimate a first spatial beam pattern to be applied to the first laser beam as an estimated eigenmode of the atmospheric channel based on the second spatial beam pattern.

### CROSS-REFERENCES TO RELATED APPLICATIONS

This application claims the benefit of German Patent Application Number 10 2024 130 305-0 filed on Oct. 18, 2024 the entire disclosure of which is incorporated herein by way of reference.

### FIELD OF THE INVENTION

The invention relates to an optical terminal, an optical system, as well as to a method for free-space optical communication.

### BACKGROUND OF THE INVENTION

Atmospheric turbulence typically distorts the wavefront of optical beams in free-space optical communication links. Such distortions apply to beams in classical free-space optical communications as well as those used for quantum communication such as Quantum Key Distribution, QKD. The distortions to the wavefront of the optical beam can cause significant link losses at the receiver. These distortions cause even more severe problems in quantum communications using QKD than for classic optical communications because it is not possible to amplify quantum signals and so QKD free space setups require larger telescopes due to the fewer optical power. However, when the diameter of the telescope becomes larger than the coherence length of the wavefront, also known as Fried parameter, the telescope cannot efficiently focus the received light anymore.

Furthermore, for classic optical communications, it is possible to sample a part or portion of the received optical beam to measure the wavefront, for example using a Shack-Hartmann wavefront sensor, and then correct the wavefront according to the measured wavefront using a deformable mirror or the like.

Therefore, correcting the wavefront of the QKD signal is very challenging because on the one hand side, it is impossible to clone the single photons, which are used to encode the quantum key. On the other hand, the single photons would not have enough intensity to be measured with conventional wavefront correction techniques. Efforts to measure the wavefront of single photons are complex and not yet mature at the time of filing.

Current solutions for correcting the wavefront distortion rely on adaptive optics. For quantum key distribution, this implies using a second, more powerful optical beam to measure the wavefront error and then apply the same correction also to the quantum beam. There are some theoretical approaches to use Bessel beams, Airy beams, pin beams or other free space modes to increase the resilience regarding atmospheric turbulence. Furthermore, some types of beams appear to be theoretically able to self-heal after a small obstacle.

The publication Klug et al. “Robust structured light in atmospheric turbulences” Advanced Photonics, Vol. 5, Issue 1, 016006 (February 2023) describes the use of a spatial mode, which is the eigenvalue of the atmospheric channel, in such a way that it would propagate without distortions. It is suggested to apply this method to quantum tomography.

In this invention, the present invention is directed to improve the means for compensation of distortions caused by the turbulent atmosphere in an atmospheric channel.

### SUMMARY OF THE INVENTION

According to the invention, this problem may be solved by the subject matter of one or more of the embodiments described herein.

According to a first aspect of the invention, an optical terminal for free-space optical communication is provided. The optical terminal comprises a transmitting part configured to generate a plurality of first laser signals, wherein a phase and/or an amplitude of each of the plurality of first laser signals are encoded for forming a first laser beam according to an initial first spatial beam pattern by coherently combining, a beam combining part configured to form the first laser beam by coherently combining the plurality of first laser signals, transmit the first laser beam towards a target through an atmospheric channel, receive a second laser beam having an altered second spatial beam pattern and spatially divide the second laser beam into a plurality of second laser signals, a receiving part configured to detect a phase and/or and an amplitude of the plurality of second laser signals for determining the altered second spatial beam pattern, and a controller connected to the transmitting part, the receiving part and the beam combining part, and configured to determine the altered second spatial beam pattern by analyzing the detected plurality of second laser signals, estimate, by an estimator unit of the controller, a first spatial beam pattern to be applied to the first laser beam as an estimated eigenmode of the atmospheric channel based on the altered second spatial beam pattern, and control the beam combining part for forming the first laser beam according to the estimated first spatial beam pattern.

According to a second aspect of the invention, an optical system for free-space laser communication is provided. The optical system comprises a first optical terminal according to any of the previous claims and a second optical terminal according to the previous claims, wherein the first optical terminal transmits the first laser beam having an initial first spatial beam pattern towards the second optical terminal and the second optical terminal transmits the second laser beam having an initial second spatial beam pattern towards the first optical terminal, and wherein the second optical terminal receives the first laser beam having an altered first spatial beam pattern, and wherein the first optical terminal receives the second laser beam having an altered second spatial beam pattern.

According to a third aspect of the invention, a method for free-space optical communication is provided. The method for free-space optical communication comprises generating a plurality of first laser signals on a first optical terminal, wherein the plurality of first laser signals are encoded for forming a first laser beam according to an initial first spatial beam pattern by coherent combining, coherently combining the plurality of first laser signals to form a first laser beam having the first spatial beam pattern, transmitting the first laser beam to a target on the atmospheric channel towards a second optical terminal, receiving the first laser beam by a receiving part of a second optical terminal, the first laser beam having an altered first spatial beam pattern on the second optical terminal side, determining, by an estimator unit of a controller of the second optical terminal, a second spatial beam pattern applied to a second laser beam based on the altered first spatial beam pattern, forming a second laser beam having the second spatial beam pattern by coherently combining a plurality of second laser signals by a beam combining part of the second optical terminal, wherein the plurality of second laser signals are encoded for forming the second laser beam according to the second spatial beam pattern by coherent combining, and transmitting the second laser beam having the second spatial beam pattern towards the first optical terminal on the atmospheric channel.

A fundamental idea of the invention is to provide a way to solve the eigenvalue problem numerically for the optical turbulent channel, which changes on the kilohertz scale, fast and continuously. The invention provides a method and a corresponding optical terminal that exploits the eigenmodes of the atmospheric channel to optimize a free space quantum and classical optical communication link.

A fundamental concept of the present invention is the physical implementation and the method for estimating the eigenmodes of the atmospheric channel, which is also applicable to quantum communication. This is done by initially estimating an eigenmode of an atmospheric channel based on an estimation and apply the estimated eigenmode as a first pattern onto the transmitted optical beam. The terminal of the receiving side then analyses the received optical beam, now having an altered beam pattern or altered optical mode due to the atmospheric channel. Based on the received beam pattern, the terminal of the receiving side then estimates an updated second spatial beam pattern applied to an optical, which is sent back to the first terminal.

The invention includes a method to implement an airborne optical and quantum communication system. It leverages a transmitter to achieve a conformal design, and singular value decomposition (SVD) for optimizing the communication channel. Regarding prior art, the SVD is used in the present invention not only to compensate for the atmospheric distortions, but also to optimally coupling the light to the discrete elements of the receiving optical terminal. This allows using smaller or sparser apertures (e.g. non-redundant optical phased arrays), thereby reducing cost and power consumption. The present invention proposes a fast iterative procedure, where the state of the laser beams is represented by the parameters of the beam combiners (the delays introduced by the phase shifter and the gain of the amplifiers).

The coherent beam combiner has the purpose of combining the optical beams in such a way to maximize the coupling to the receiving terminal. If we consider only the optical atmospheric channel, this is equivalent to performing the SVD of the atmospheric channel and determining the left and right eigenvectors. The idea is that the SVD allows one to determine the most efficient eigenmodes of the atmospheric channel. In case where the two optical terminals are identical, the atmospheric channel can be modeled as a square matrix and performing the SVD is equivalent to finding the eigenmodes. Furthermore, a finite coherence time of the atmospheric turbulence (of the order of several milliseconds) is considered to predict the eigenvalues of the turbulent communication channel and to adjust in real time the spatial profile of the optical beam, so to track the channel eigenmodes.

The advantage regarding the prior art is that the invention provides an iterative and fast way to constantly estimate the spatial eigenmodes of the atmospheric channel. Regarding adaptive optics, the present invention provides a simpler and more efficient method to clean a beam from wavefront distortions. In particular, adaptive optics can only correct the wavefront in the region, where the local intensity is sufficiently high, which is not a limitation in the present invention. With respect to using Bessel beams or another ad hoc spatial beam shape, the current approach is more general, and potentially more efficient because it automatically finds the best mode for the specific communication channel.

The optical terminal is typically capable of adjusting the divergence of the laser beam dynamically, depending on the link distance and on the pointing accuracy onto the target. For example, the optical terminal may increase the beam divergence, when the mechanical vibrations make accurate pointing more challenging. The combiner part forming the laser beam can also compensate for the atmospheric turbulence and efficiently couple the light of a corresponding combining part and receiving part of a receiving optical terminal.

A spatial beam pattern is to be understood as a spatial pattern, which contains information about amplitude and/or phase distributions of the wavefront of the beam, which are applied to the optical beams. The spatial patterns typically are pixel-based so that elements, such as an optical phased array elements or others, can be addressed accordingly. The light source typically is a narrow line width laser, such as an DFB-laser diode, and preferably outputs as single, i.e., Gaussian spatial mode, although the invention is not limited to this. An altered spatial beam pattern is to be understood as the spatial beam pattern that has been changed due to the propagation through the optical (atmospheric) channel between the two terminals. In the ideal case, the beam pattern on the transmitting optical terminal and the “altered” beam pattern on the receiving side should be the same. However, in reality, due to the dynamic changes of the atmospheric channel, the altered beam pattern generally differs from the transmitted beam pattern.

At the beginning of the process, an initial first spatial beam pattern as a first guess is applied to the beam combiner to form the first laser beam. Such an initial spatial pattern may be, for example, one of the Laguerre-Gaussian modes. After some iterations with the second optical terminal, the precision of an updated spatial pattern then better corresponds to the eigenmode of the turbulent channel between the first and second communication terminals.

According to some aspects according to the invention, the estimator unit is configured to estimate the first spatial beam pattern based on the altered second spatial beam pattern and historical data used in a probability matrix scheme. The estimator unit thus includes a processor and a memory unit for conducting the estimation of the first spatial beam pattern. The estimator uses a probability matrix scheme in addition to the detected altered second spatial beam pattern. The estimator thus also applies the spatial beam patterns as respective state vectors to the probability matrix scheme to predict updated state vectors, that are applied as updated beam patterns to the respective combined laser beam. The state vectors contain information about the amplitude and/or phase of the laser signals to be combined coherently.

According to some aspects according to the invention, the estimator unit includes a Kalman Filter. Such a Kalman Filter uses the probability matrix scheme to generate the estimated state vector corresponding to the first spatial beam pattern. By using a fast estimator, which is based by an extension of Kalman filters, the optical terminal of the present invention can track the eigenmode of the turbulent atmospheric channel much faster than in the prior art, which typically require the full characterization of the optical channel. The estimator may also include a neural network to estimate and predict the (updated) first spatial beam pattern.

According to some aspects according to the invention, the transmitting part includes a generation unit for generating a plurality of laser signals and an encoding unit for encoding the plurality of laser signals for forming the first laser beam according to a first spatial beam pattern by coherent combining the first laser signals. A particular encoding unit allows the individual control of each laser signal with great precision and a minimum of noise. A generation unit allows a precise generation of layer signal beams according to predetermined properties, such as narrow-linewidth, single spatial mode etc.

According to some aspects according to the invention, the encoding unit includes a plurality of first amplitude modulators, preferably amplifiers, and/or a first plurality of phase shifters for encoding the amplitude and/or phase of the first laser signals. By the encoding unit comprising a plurality of amplitude and/or phase modulators, the first or second spatial beam patterns may be formed with great precision based on the estimated beam patterns. In preferred embodiments, the encoding unit includes bother amplitude modulators and phase shifters for precise coherent combining. However, the encoding unit may include only amplitude modulators or only phase modulators, thereby saving components and reducing complexity of the system of the cost of precision.

According to some aspects according to the invention, the generation unit is configured to modulate each of the plurality of first laser signals. The controller is configured to address the generation unit to modulate the plurality of first laser signals according to the first spatial beam pattern. With such a modulation capability, it is possible to encode data onto the first laser beam in a classical way using a commonly used classical modulation scheme, such as ON/Off-Keying, FWM, FPSK, QPSK and others, which can be applied e.g. using phase shifters and other common optical elements. In this invention, information about the initial first spatial beam pattern as formed by the beam combining part is encoded onto the first laser beam. This enables a receiver to read out the initial first spatial beam pattern before the beam was transmitted through the atmospheric channel to obtain additional information about the atmospheric turbulences caused by the atmosphere on the atmospheric channel.

According to some aspects according to the invention, the receiving part comprises a decoding unit for decoding the plurality of second laser signals according to an estimated second spatial beam pattern, and a detection unit configured to detect the plurality of decoded second laser beam signals to provide corresponding electric signals.

According to some aspects according to the invention, the decoding unit comprises a plurality of third amplitude modulators, and/or a plurality of third phase shifter for decoding the amplitude and/or phase of the second laser signals. By this, the decoding unit applies an estimated guess of the second laser beam pattern to the amplitude modulators and phase shifter for obtaining information about the altered second laser beam pattern.

According to some aspects according to the invention, the detection unit is configured to demodulate the second laser beam to obtain received data about an initial second spatial beam pattern. This embodiment specifies the receiving part having a detection unit that is capable to demodulate the received sent second laser beam and read out the information of the initial beam pattern of the second laser beam, which is the beam pattern applied to the second laser beam at the transmitter terminal before it was sent through the atmospheric channel and got distorted to become the altered second spatial beam pattern. Such demodulation may be done by conventional modulators based on ON/Off-Keying, FWM, FPSK, QPSK and others.

The controller is configured to determine the first spatial beam pattern based on the initial second spatial beam pattern. This provides additional information to the estimator unit for estimating the (updated) first spatial beam pattern, thus increasing the precision to form the eigenmode of the atmospheric channel.

According to some aspects according to the invention, the combiner unit comprises a plurality of optical circulators configured to direct the plurality of first laser signals from the transmitting part to the radiator unit and direct the plurality of second laser signals from the radiator unit towards the receiving part. In this way, incoming and outgoing laser signals can be separated accurately.

According to some aspects according to the invention, the beam combining part includes a radiator unit, which is configured to form the first laser beam by coherently combining the plurality of first laser signals and spatially divide the received second laser beam into a plurality of second laser signals. The transmission of the first laser beam and the reception of the second laser beam is thus performed by the same optical aperture. Such radiator unit may have multiple apertures with diameter smaller than the typical coherence length of the optical beam (Fried parameter). In this way, a more compact design of the terminal and combiner unit can be achieved.

According to some aspects according to the invention, the radiator unit includes a phased array comprising a multiple of radiation elements, which are arranged on a radiation plane. The radiation elements may have apertures with diameter smaller than the typical coherence length of the optical beam (Fried parameter). The advantage of this embodiment regarding the prior art is that the solution leads to a flat conformal design, which is suitable for deployment on an aircraft. Regarding solutions based on using phase masks for generating specific beam shapes (e.g. Bessel beams), our solution is more general and can yield not only specific beam shapes like Gaussian or Bessel beams but also ad-hoc beam shapes adapted to the specific atmospheric channel.

According to some aspects according to the invention, the radiation elements are arranged randomly on the radiation plane. In some of these embodiments, a non-redundant phased array is formed by such arrangement. Regarding prior art solutions based on optical phased arrays, the number of elements and phase shifters are greatly reduced as it is described e.g. in Fukui et al. “Non-redundant optical phased array”, Optica Vol. 8, Issue 10, pp. 1350-1358 (2021).

According to some aspects according to the invention, the first laser beam comprises a first classical laser beam and a first quantum laser beam. The second laser beam comprises a second classical laser beam and a second quantum laser beam. The plurality of first laser signals comprises a plurality of first classical laser signals and a plurality of first quantum signals, wherein the plurality of second laser signals comprises a plurality of second classical laser signals and a plurality of second quantum signals. The first and second laser beams are thus overlaid by a corresponding classical optical beam and a quantum optical beam. In the present invention, classical and quantum communication are thus combines in one terminal. For this purpose, the classical channel comprising the classical first laser signals may be used for both communicating data and for determining the eigenmodes of the communication channel. The same eigenmodes may then be used for both the classical and the quantum communication channels. In this way, the optical terminals are suitable for quantum communication links, such as QKD, and classical optical terminals for corresponding free-space laser communication links.

According to some aspects according to the invention, the transmitting part includes a quantum generation unit comprising a plurality of photon sources configured to emit the plurality of first quantum signals. The photon source may be a single photon source or a weak pulse source, wherein weak means less than one photon per pulse in average. Furthermore, the transmitting part includes a quantum encoding unit configured to encode the plurality of first quantum beams for forming the first quantum laser beam according to a first spatial beam pattern by coherent combining these first quantum beams.

According to some aspects according to the invention, the quantum encoding unit comprises a plurality of second amplitude modulators, preferably attenuators, and/or a plurality of second phase shifter for encoding the amplitude and/or phase of the first quantum laser signals. These components provide a reliable means to control the amplitude and phase of the quantum signals. In contrast to the encoding or decoding units for the classical beams, the encoder for the quantum signals preferably apply attenuators to control the amplitude of the quantum signals, which does not influence the property of the photon in QKD.

According to some aspects according to the invention, the transmitting part comprises a plurality of multiplexers, which are configured to overlay the first laser signals with the first quantum signals, and wherein the receiving part comprises a plurality of demultiplexers configured to separate the second classical laser signals from the second quantum signals. Such multiplexer or demultiplexers may be chromatic filters, polarization (beam) splitters/combiners, phase plates and the like that can separate beams by a difference of a particular optical property, such as wavelength, polarization, phase etc. In this way, quantum signals and classical laser signals can be multiplexed or demultiplexed efficiently.

According to some aspects according to the invention, the receiving part comprises a quantum detection unit configured to detect the plurality of second quantum signals by a corresponding amount of single photon counters. Single photon counters provide reliable detection signals in a quantum channel.

According to some aspects according to the invention, the optical terminal further comprises a tracking part configured to steer the first laser beam towards the target. The tracking part includes at least one optical beam steering element. Such tracking part allows tracking the target, which may be a similar optical terminal. Such a tracking system has a beam steering element, such as a rotatable steering mirror or the like, arranged on an optical axis the first and second laser beam are propagating on. The steering element points the optical axis towards the target. Such a tracking part may also comprise a fine pointing/steering element and a coarse pointing/steering element.

According to some aspects according to the invention, wherein the beam steering element is configured as a flat steering element. A flat beam steering element is space-saving and particularly beneficial with a phased array to increase the steerable angle. Since the beam forming ability of the encoding unit and the phased array radiator typically has a tradeoff between pointing accuracy and field of view, a steering element may be beneficial. In this way, an airborne platformed can be realized efficiently. Preferably, the flat beam steering element is a Risley prism, which comprises two optical wedges that rotate relative to each other, with the rotation axis on or parallel to the optical axis.

According to some aspects according to the invention, the tracking system includes an area-sensitive detector configured to detect the incoming direction of the second laser beam. The tracking part is configured to direct the at least one optical beam steering element towards the target based on the detected incoming direction. By a sensor, such as a quadrant diode or a camera, the orientation of the at least one optical beam steering element is controlled so that the optical axis is corrected to point to the target and the beam combining part.

According to some aspects according to the present invention, the method further comprises receiving the second laser beam having an altered second spatial beam pattern on the first optical terminal, determining, by an estimator unit of the controller on the first optical terminal, an updated first spatial beam pattern to be applied to the first laser beam based on the altered second spatial beam pattern, forming the first laser beam by coherently combining the plurality of first laser signals according to the updated first spatial beam pattern by the beam combining part of the first optical terminal, and transmitting the first laser beam having the updated first spatial beam pattern towards the second optical terminal on the atmospheric channel. This embodiment further describes the iteration process to track the eigenmode of the atmospheric channel by the first and second optical terminal.

According to some aspects according to the present invention, the method further comprises modulating, by a generation unit of the first terminal, the first laser signals with information about the initial first spatial beam pattern, demodulating, by a detection unit of the second optical terminal, the received first laser beam to receive data about the initial first spatial beam pattern, and determining, by the estimator unit of the second optical terminal, the second spatial beam pattern applied to the second laser beam based on the altered first spatial beam pattern and the initial first spatial beam pattern. This increases the speed and accuracy of the tracking of the eigenmode of the atmospheric channel.

The above embodiments and further developments can be combined with each other as desired, if useful. In particular, all features of the optical terminal for free space optical communication are transferable to the optical system for free space optical communication and the method for free space optical communication, and vice versa. Further possible embodiments, further developments and implementations of the invention also comprise combinations, not explicitly mentioned, of features of the invention described before or below with respect to the embodiments. In particular, the skilled person will thereby also add individual aspects as improvements or additions to the respective basic form of the present invention.

Advantageous embodiments and further developments emerge from the description with reference to the figures.

### BRIEF DESCRIPTION OF THE DRAWINGS

The present invention is explained more specifically below on the basis of the exemplary embodiments indicated in the schematic figures, in which:

FIG. 1 shows a schematic illustration of an optical system comprising two optical terminals according to an embodiment of the invention;

FIG. 2 shows a flow chart for a method for free-space optical communication according to an embodiment of the invention;

FIG. 3 shows a schematic illustration of an optical terminal according to an embodiment of the invention;

FIG. 4 shows a schematic illustration of an implementation of encoder units and a combiner part of an optical terminal according to an embodiment of the invention;

FIG. 5 shows a schematic illustration of an optical terminal according to a further embodiment of the invention;

FIG. 6 shows a schematic illustration of an optical system including optical terminals according to a further embodiment of the invention;

FIG. 7 shows a schematic illustration of an optical system including optical terminals according to a further embodiment of the invention;

FIG. 8 shows a schematic illustration of an estimator unit of a controller of an optical terminal according to a further embodiment of the invention; and

FIG. 9 shows a diagram of a prediction of a state vector made by an estimator unit of a controller of an optical terminal according to a further embodiment of the invention.

In the figures of the drawing, elements, features and components which are identical, functionally identical and of identical action are denoted in each case by the same reference designations unless stated otherwise.

### DETAILED DESCRIPTION OF THE PREFERRED EMBODIMENTS

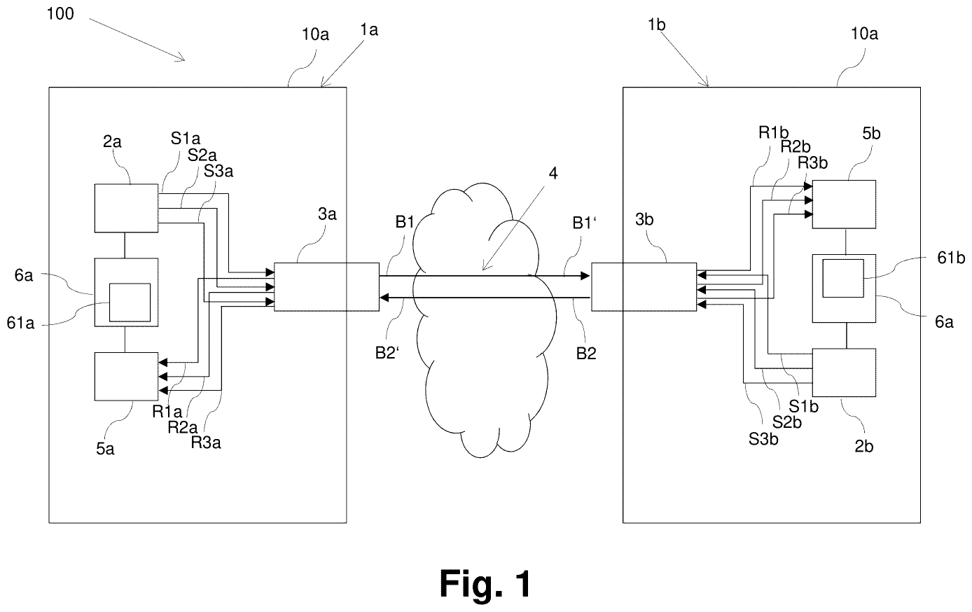

FIG. 1 shows a schematic illustration of an optical system comprising two optical terminals according to an embodiment of the invention.

The optical system 100 for free space laser communication, comprising a first optical terminal 1a and a second optical terminal 1b. Each of the first and second optical terminals 1a, 1b comprises a transmitting part 2a, 2b. The respective transmitting part 2a, 2b is configured to generate a plurality of first laser signals S1a-S3a, S1b-S3b. The transmitting part 2a, 2b is configured to generate the laser signals S1a-S3a, S1b-S3b such that a phase and/or an amplitude of each of the plurality of first laser signals S1a-S3a, S1b-S3b are encoded for forming a first laser beam B1 according to a first spatial beam pattern by coherently combining. In preferred embodiments, the phase and the amplitude of each of the plurality of first laser signals S1a-S3a, S1b-S3b are encoded for forming a first laser beam B1 according to a first spatial beam pattern by coherently combining. The first spatial beam pattern is to be understood as a spatial pattern or optical mode, which contains information about amplitude and/or phase distributions of the wavefront of the beam, which are applied to the optical beams so that an optical mode of the first laser beam B1 corresponds to the first spatial beam pattern.

Each optical terminal 1a, 1b further comprises a beam combining part 3, 3a, 3b, which is configured to form the first laser beam B1 by coherently combining the plurality of first laser signals S1-S3, S1a-S3a, S1b-S3b. The beam combining part 3, 3a, 3b is also configured to transmit the first laser beam B1 towards a target through an atmospheric channel 4. In some embodiments, a specific tracking part 7 is applied for the precise beam steering and tracking, as will be described further below. The beam combining part 3, 3a, 3b is further configured to receive a second laser beam B2 having an altered second spatial beam pattern and spatially divide the second laser beam B2 into a plurality of second laser signals R1a-R3a, R1b-R3b. Although in FIG. 1, the beam paths of the first and second laser beams B1, B2 are drawn antiparallel with a slight offset to each other, the first and second laser beams B1, B2 are overlaid, thus propagating through the same aperture on the same atmospheric channel 4. In some embodiments, the first and second laser beams B1, b2 may have a slight offset, thus propagating through the different apertures on a similar atmospheric channel 4.

Each of the optical terminals 1a, 1b further comprises a receiving part 5, 5a, 5b, which is configured to detect a phase and/or and an amplitude of the plurality of second laser signals R1a-R3a, R1b-R3b for determining the altered second spatial beam pattern. The spatial beam pattern of the second laser beam is altered due to the atmospheric channel 4, which distorts the wavefront of the optical beam due to refractive index variations.

Each of the optical terminals 1a, 1b further comprises a controller 6a, 6b, which is connected to the respective transmitting part 2a, 2b, the receiving part 5a, 5b and the beam combining part 3a, 3b of the respective optical terminal 1a, 1b. Each of the controllers 6a, 6b is configured to determine the altered second spatial beam pattern by analyzing the detected plurality of second laser signals R1a-R3a, R1b-R3b. Each of the controllers 6a, 6b, comprises an estimator unit 61a, 61b. Each of estimator units 61a, 61b is configured to estimate a first spatial beam pattern to be applied to the first laser beam B1 as an estimated eigenmode of the atmospheric channel 4 based on the altered second spatial beam pattern.

Each of the controllers 6a, 6b is further configured to control the beam combining part 3a, 3b for forming the first laser beam B1 according to the estimated first spatial beam pattern. The estimated first spatial beam pattern is thus an updated first spatial beam pattern to be applied to the first laser beam for propagating through the atmosphere. Information about how to form the updated spatial beam pattern is extracts from the information of the altered second laser beam B2, which has experienced the same or similar distortions that are to be expected for the first laser beam B1 when propagating through the atmospheric channel with the same of nearly the same optical properties. In some embodiments, the estimator unit 61, 61a, 61b is configured to estimate the first spatial beam pattern based on the altered second spatial beam pattern and historical data used in a probability matrix scheme. For this, typically, state vectors are created by the detected second laser signals that are feed into the matrix scheme to estimate the updated first spatial beam pattern based on the detected altered second spatial beam pattern and such estimate. In preferred embodiments, the estimator unit 61, 61a, 61b includes a Kalman Filter, which makes use of such deterministic probability scheme and provides reliably accurate estimated data. Due to the matrix scheme including state vectors including the amplitude and/or phase information about the patterns, a fast processing time is obtained. Such fast processing time is important since the atmospheric turbulences change in the kHz order.

The first optical terminal 1a transmits the first laser beam B1 having an initial first spatial beam pattern towards the second optical terminal 1b. The second optical terminal 1b transmits the second laser beam B2 having an initial second spatial beam pattern towards the first optical terminal 1a. The second optical terminal 1b thus receives the first laser beam B1 having an altered first spatial beam pattern due to turbulences in the atmospheric channel 4. The first optical terminal 1a receives the second laser beam B2 having an altered second spatial beam pattern as well due to turbulences in the atmospheric channel 4.

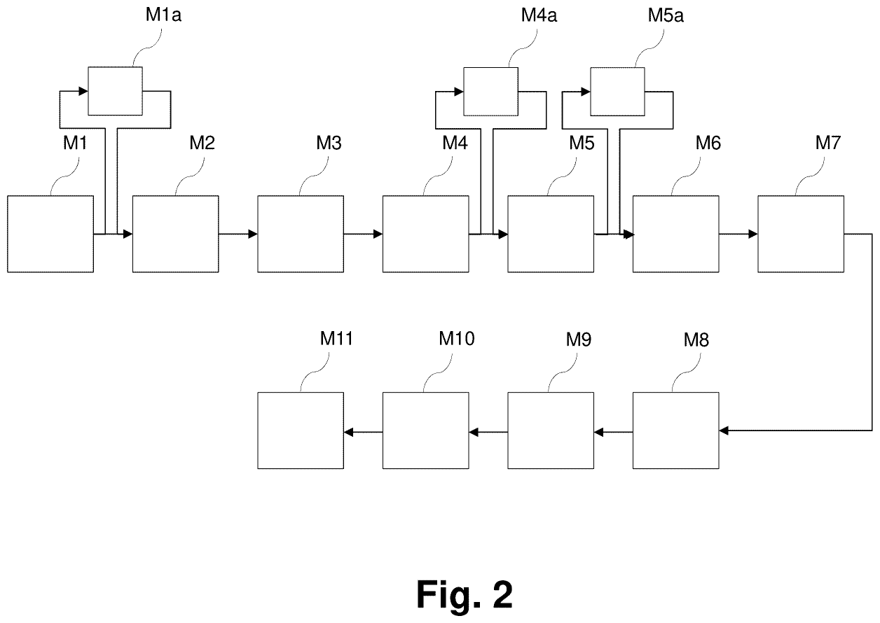

FIG. 2 shows a flow chart for a method for free-space optical communication according to an embodiment of the invention.

In the method for free-space optical communication, a plurality of first laser signals S1a-S3a on a first optical terminal 1a are generated M1. The plurality of first laser signals S1a-S3a are encoded for forming a first laser beam B1 according to a first spatial beam pattern by coherent combining. In a following step M2, the plurality of first laser signals S1a-S3a are coherently combined M2 to form a first laser beam B1 having the first spatial beam pattern.

Then, the first laser beam B2 is transmitted M3 to a target on the atmospheric channel 4 towards a second optical terminal 1b. The first laser beam B1 is received M4 by a receiving part 5b of a second optical terminal 1b. Here, the first laser beam B1 has an altered first spatial beam pattern on the second optical terminal 1b side due to the propagation through the atmospheric channel 4.

In a following step, a second spatial beam pattern applied to the second laser beam B2 is determined M5 by an estimator unit 61b of a controller 6b of the second optical terminal 1b based on the altered first spatial beam pattern. A receiving part 2b of the second optical terminal 1b thus analyses the received second laser beam by decomposing the second laser beam into a plurality of corresponding first laser signals and extracting the amplitude and/or phase, preferably both, of these first laser signals on the second optical terminal 1b.

A second laser beam B2 having the second spatial beam pattern is formed M6 by coherently combining a plurality of second laser signals S1b-S3b by a beam combining part 3b of the second optical terminal 1b. The plurality of second laser signals S1b-S3b are encoded for forming the second laser beam B2 according to the second spatial beam pattern by coherent combining. In a further step, the second laser beam B2 having the second spatial beam pattern is transmitted M7 towards the first optical terminal 1a on the atmospheric channel 4.

In some embodiments of the method, the second laser beam B2 having an altered second spatial beam pattern is received M8 by the first optical terminal 1a. An estimator unit 61a of the controller 6a on the first optical terminal 1a estimates or determines M9 an updated first spatial beam pattern to be applied to the first laser beam B1 based on the altered second spatial beam pattern. Then, the first laser beam B1 is formed M10 by coherently combining the plurality of first laser signals S1a-S1b according to the updated first spatial beam pattern by the beam combining part 3a of the first optical terminal. The first laser beam B1 having the updated first spatial beam pattern are then transmitted M11 towards the second optical terminal 1b on the atmospheric channel 4.

In some embodiments, the method further comprises a step of modulating M1a the first laser signals S1a-S3a with information about the initial first spatial beam pattern by a generation unit 21 of the first optical terminal 1a. In these embodiments, the received first laser beam B1 is demodulated M4a to receive data about the initial first spatial beam pattern by a detection unit 52 of the second optical terminal 1b. Then, an estimator unit 61b of the second optical terminal 1b estimates or determines M5a the second spatial beam pattern applied to the second laser beam B2 based on the altered first spatial beam pattern and the initial first spatial beam pattern. The data sent are encoded by classical modulation schemes on the transmitted first and second optical beams B1, B2 are decoded by demodulators or the like on the respective receiving side, i.e., on the first and second optical terminal 1a, 1b. This gives the estimator additional information about the atmospheric channel that facilitates and allows and more precise prediction of the eigenmode of the atmospheric channel 4.

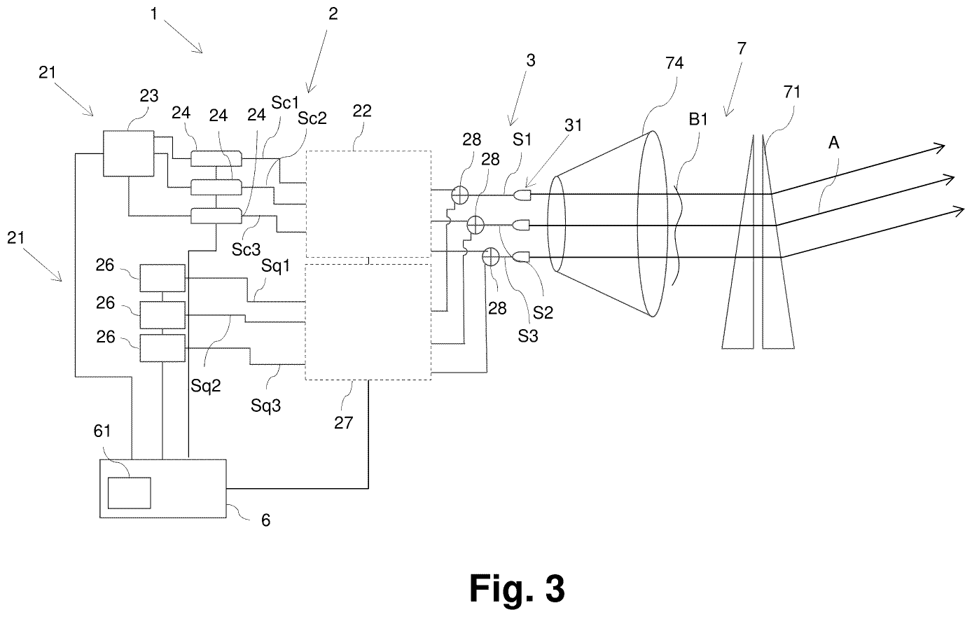

FIG. 3 shows a schematic illustration of an optical terminal according to an embodiment of the invention.

FIG. 3 describes a part of an optical terminal 1, which is based on the embodiments of the optical terminals 1, 1a-e described so far with reference to FIG. 1 and the method described in FIG. 2. In this embodiment of FIG. 3, only the transmitting part 2 and the combining part 3 of an optical terminal 1 are shown. In this embodiment of the optical terminal 1, the first laser beam B1 comprises a first classical laser beam and a first quantum laser beam (not explicitly shown in FIG. 3), which are overlaid on each other to form the first laser bam B1.

The transmitting part 2 includes a generation unit 21 for generating a plurality of laser signals S1-S3. The generation unit 21 is configured to modulate each of the plurality of first laser signals S1-S3. The transmitter part 2 further comprises an encoding unit 22 for encoding the plurality of laser signals S1-S3 to form a first laser beam B1 according to a first spatial beam pattern by coherently combining the plurality of laser signals S1-S3. The controller 6 is configured to address the generation unit 21 to modulate the plurality of first laser signals S1-S3, which are in this embodiment first classical laser signal Sc1-Sc3, according to the first spatial beam pattern. This means that the controller 6 addresses the modulators 24 of the generation unit 21 to modulate each of the first classical laser signals Sc1-Sc3.

The transmitting part 2 further includes a quantum generation unit 25 comprising a plurality of photon sources 26 configured to emit the plurality of first quantum signals Sq1-Sq3. The photon sources 26 may be a single photon sources or a weak pulse sources, wherein weak means less than one photon per pulse in average. The transmitting part 2, 2a, 2b includes a quantum encoding unit 27 configured to encode the plurality of first quantum signals Sq1-Sq3 for forming the first quantum laser beam of the first laser beam B1 according to a first spatial beam pattern by coherent combining. The photon sources 26 generate corresponding quantum or QKD channels, which are encoded with a corresponding coding scheme, such as BB84, E91, etc. For simplicity, details of encoding are omitted here.

The transmitting part 2 further comprises a plurality of multiplexers 28, which are configured to overlay the first classical laser signals Sc1-Sc3 with the first quantum signals Sq1-Sq3. The plurality of first laser signals S1-S3 thus comprises a plurality of first classical laser signals and a plurality of first quantum signals Sq1-Sq3.

In preferred embodiments, the second laser beam B2 comprises a second classical laser beam and a second quantum laser beam, which are described further below. The plurality of second laser signals R1-R3 comprises a plurality of second classical laser signals Rc1-Rc3 and a plurality of second quantum signals Rq1-Rq3.

In addition, the beam combining part 3 includes a radiator unit 31, which is configured to form the first laser beam B1 by coherently combining the plurality of first laser signals S1-S3. On the other hand, for the incoming second laser beam B2, the radiator unit 31 is configured to spatially divide the received second laser beam B2 into a plurality of second laser signals R1-R3.

In some embodiments, the radiator unit 31 includes a phased array comprising a multiple of radiation elements 311, which are arranged on a radiation plane. In some embodiments, the radiation elements 311 are arranged randomly on the radiation plane. In some of these embodiments, a non-redundant phased array is formed by such an arrangement, which reduces the numbers of phase shifters as described above.

The optical terminal 1 shown in FIG. 3 further comprising a steering and tracking part 7, which is configured to steer the first laser beam B1 towards the target. The tracking part 7 includes at least one optical beam steering element 71, which is configured as a Risley prism, i.e., a pair of rotating wedges, as one possible form of a flat steering element. The Risley prism is configured to enhance a steering angle of the phased array. Furthermore, a flat steering element is preferably used in an airborne application, such as an aircraft, due to less drag.

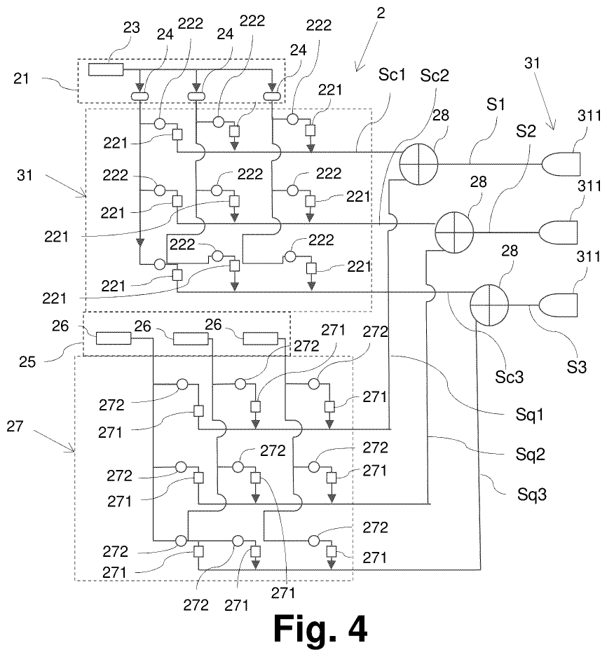

FIG. 4 shows a schematic illustration of an implementation of encoder units and a combiner part of an optical terminal according to an embodiment of the invention.

The example implementations of the encoder unit 22 and the quantum encoder unit 27 shown in FIG. 4 are based on and compatible with all the encoding unit 22, 27 as described before and respectively applicable for a corresponding decoding units 53 of the receiving part of the optical terminals 1, 1a-e described throughout this specification.

The encoding unit 22 is fed by modulated laser signals, which have been generated by laser sources 23 and modulated by respective modulators 24 of a generation unit 21. The encoding unit 22 includes a plurality of first amplitude modulators 221, which in preferred embodiments, are configured as amplifiers, and a first plurality of phase shifters 222. These amplitude modulators 221 and phase shifters 222 are addressed by a control unit 6 for encoding the amplitude and phase of the first classical laser signals Sc1-Sc3.

The quantum encoding unit 27 is fed by first quantum signals Sq1-Sq3, which are generated by photon sources 26 of a quantum generation uni 25. The quantum encoding unit 27 comprises a plurality of second amplitude modulators 271, which, in preferred embodiments, are configured as attenuators, and a plurality of second phase shifter 272 for encoding the amplitude and phase of the first quantum laser signals Sc1-Sc3. Amplifiers are thus used for the classical laser signals Sc1-Sc3, while for the quantum signals Sq1-Sq3, using attenuators is more beneficial, especially in combination with weak pulse photon sources as the photon sources 26. In such cases, the attenuators are set in such a way as to ensure the correct mean photon number per pulse at the exit aperture of the optical terminal 1.

Shown in FIG. 4 are the multiplexers 28, which are configured to overlay the first classical laser signals Sc1-Sc3 with the first quantum signals Sq1-Sq3 to feed the phased array as the radiator 31 comprising the plurality of radiation elements 331 as described with reference to FIG. 3.

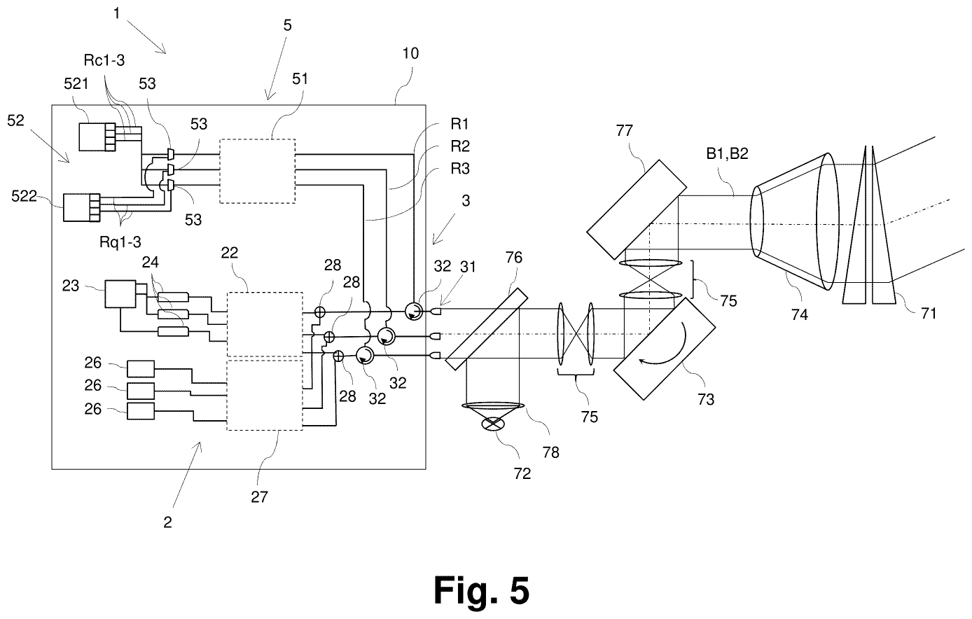

FIG. 5 shows a schematic illustration of an optical terminal according to a further embodiment of the invention.

The optical terminal 1 shown in FIG. 5 is based on and compatible with the optical terminals 1, 1a-e and the method described so far with reference to FIG. 1 to 4. In particular, the transmitting part 2 shown in FIG. 5 is based on the transmitting part 2 described in the embodiment with reference to the previous FIG. 4.

In this embodiment, the receiving part 5 comprises a decoding unit 51 for decoding the plurality of second laser signals R1-R3 according to an estimated second spatial beam pattern. In preferred embodiments, the decoding unit 51 comprises a plurality of third amplitude modulators, and a plurality of third phase shifter for decoding the amplitude and phase of the second laser signals R1-R3.

The receiving part 5 further comprises a detection unit 52 configured to detect the plurality of decoded second laser beam signals R1-R3 to provide corresponding electric signals.

In the shown embodiment, the detection unit 52 is configured to demodulate the second laser beam B2 to obtain received data about an initial second spatial beam pattern. In this embodiment, the controller 6 is configured to determine the first spatial beam pattern based on the initial second spatial beam pattern.

In the present embodiment shown in FIG. 5, the combiner unit comprises an optical circulator 32, which is configured to direct the first laser signal S1-S3 from the transmitting part 2 to the radiator unit 31 and direct the second laser signals R1-R3 from the radiator unit 31 towards the receiving part 5.

The plurality of second laser signals R1-R3b comprises a plurality of second classical laser signals Rc1-Rc3 and a plurality of second quantum signals Rq1-Rq3.

The receiving part 5, 5a, 5b comprises a plurality of demultiplexers 53 configured to separate the second laser classical laser signals Sc1-Sc3 from the second quantum signals Sq1-Sq3. Thus, the demultiplexers 53 divide the second laser signals R1-R3 into corresponding second classical laser signals Sc1-Sc3 and second quantum signals Sq1-Sq3. The demultiplexers 53 are arranged downstream the decoding unit 51 and upstream the detection unit 52.

In some embodiments, the classical laser signals Sc1-Sc3, Rc1-Rc3 and quantum signals Sq1-Sq3, Rq1-Rq3 have different wavelengths. A difference of a wavelength of the classical signals and the wavelength of the quantum signals may be between 0.5 nm and 3 nm, preferably 0.7 nm and 2 nm. In this case, the overlaying and splitting of these signals is performed by chromatic multiplexers 28 and corresponding chromatic demultiplexers 53, such as a spectral filter or a chromatic beam combiner, which may comprises a Dense Wavelength Division Multiplexing, DWDM, filter. Due to the close wavelength, the refractive index of the turbulences are essentially the same, thus causing similar wavefront distortions to the classical laser signals and the quantum signals Sq1-Sq3, Rq1-Rq3. The use of DWDM filter enables the use of a plurality of pairs of different channels for the light beam and/or the quantum beam mutually having a small spectral spacing in their wavelength, such as e.g. less than 2 nm.

Alternatively or in addition, the classical laser signals Sc1-Sc3, Rc1-Rc3 and the quantum signals Sq1-Sq3, Rq1-Rq3 may be polarized with a different polarization, preferably orthogonal polarization states, such as e.g. left-hand circular and right-hand circular polarization. The overlaying and splitting may be performed by a polarization multiplexer 28, which may include wave plates in combination with polarizing beam combiners or splitters as multiplexers 28 and demultiplexer 53. Using these components, a reliable multiplexing of the corresponding classical laser signals Sc1-Sc3, Rc1-Rc3 and the quantum signals Sq1-Sq3, Rq1-Rq3 can be obtained.

The receiving part 5 comprises a classical detection unit 521 configured to detect the plurality of second classical laser signals Rc1-Rc3 to provide corresponding electric signals. This detection unit 52 could be for example a small form factor (SPF) transceiver or another sort of photodiodes. The receiving part 5 further comprises a quantum detection unit 54 configured to detect the plurality of second quantum signals Rq1-Rq3 by a corresponding amount of single photon counters.

The optical terminal further comprising a tracking part 7, which is configured to steer the first laser beam B1 towards the target. The tracking part 7 includes at least one optical beam steering element 71, which is configured to deflect the first laser beam B1 and the second laser beam R2 on the optical axis A. In this embodiment, the beam steering element 71 is configured as a flat steering element. In this embodiment, the beam steering element 71 is configured as a Risley prism.

However, the tracking part 7 further comprises a second optical beam steering element 73, which is configured as a rotatable steering mirror, and arranged between the radiator unit 31 and the optical beam steering element 71. The second optical beam steering element 73 as well is configured to steer laser beam B1 and the second laser beam R2 by rotation of a reflecting mirror. The tracking part 7 includes an area-sensitive detector 72, which is configured to detect the incoming direction of the incident second laser beam B2. A beam splitter 76 arranged between the radiator element and the second optical beam steering element 73 extracts a part of the incident second laser beam B2, and a lens 78 focus the extracted beam onto the area-sensitive detector 72. The same controller 6 or a different specific controller (both not shown in FIG. 5) are configured to read out an electric signal of the area-sensitive detector 72 and control the second optical beam steering element 73 for directing the first laser beam B1 towards the target based on the electric signal of the area-sensitive detector 72. The second optical beam steering element 73 thus acts as a fast fine-pointing element in a tracking system, whereas the Risley prism acts as a fast coarse beam pointing element. A reflecting mirror 77 relays the beams between the steering elements 73 and 71. Furthermore, relay lenses 75 are used to map the entrance pupil of the telescope 74 to the fine steering mirror 73, the lens 78 and the radiator unit 31.

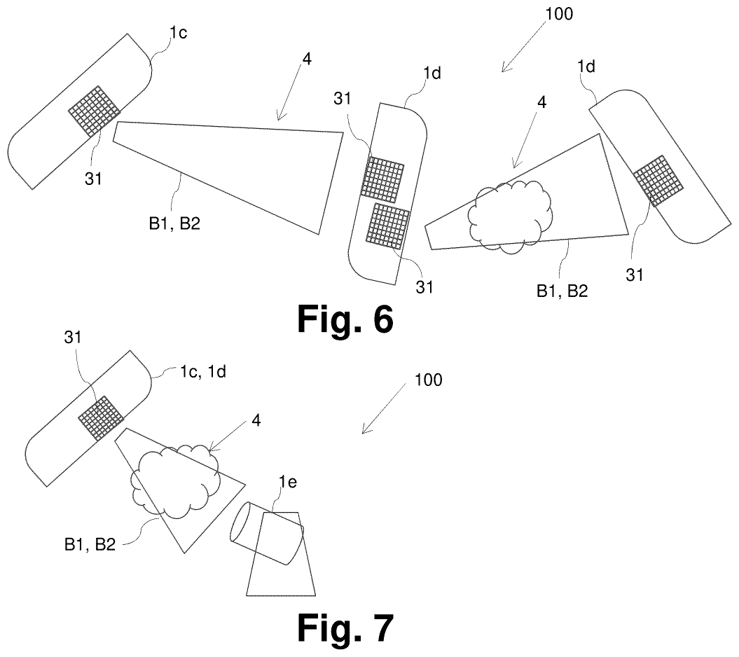

FIG. 6 shows a schematic illustration of an optical system including optical terminals according to a further embodiment of the invention. FIG. 7 shows a schematic illustration of an optical system including optical terminals according to a further embodiment of the invention.

FIGS. 6 and 7 show optical systems 100, which include optical terminals 1c-1e as described with respect to the previous embodiments shown in the previous figures. In FIG. 6, optical terminal 1c is located on a space-borne platform, such as a satellite, whereas optical terminal 1d is located on an airborne platform, such as an aircraft. Even though there is no considerable atmosphere in the channel 4 between optical terminal 1c and 1d, these optical terminals 1c, 1d may be configured as an optical terminal 1 of the present invention and may apply the method as described above.

The present invention may produce an aircraft-to-aircraft optical communication link by applying the method described above to the two airborne optical terminals 1d through the atmospheric channel 4. The optical terminals 1c, 1d carry a phased array as radiator 31 for transmitting and receiving the respective first and second laser beams B1, B2.

In FIG. 7, an example of a ground link from a space borne optical terminal 1c or an airborne optical terminal 1d communicating with a ground-based optical terminal 1e through a highly turbulent atmospheric channel 4 is shown.

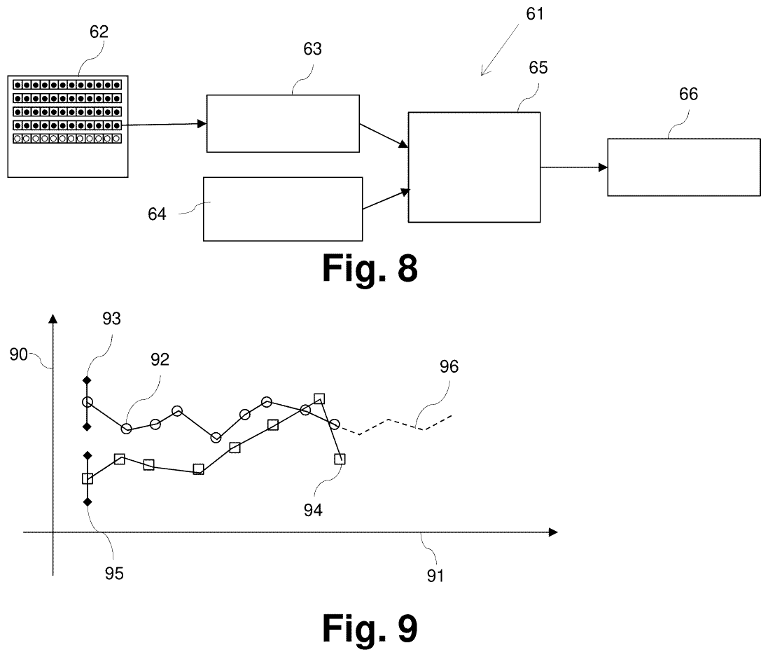

FIG. 8 shows a schematic illustration of an estimator unit of a controller of an optical terminal according to a further embodiment of the invention.

As described already with reference to FIG. 1, in some embodiments, the estimator unit 61, 61a, 61b is configured to estimate the first spatial beam pattern based on the altered second spatial beam pattern and historical data used in a probability matrix scheme. Furthermore, in preferred embodiments, the estimator unit 61, 61a, 61b preferably includes a Kalman Filter 65.

FIG. 8 explains the principle steps of such a Kalman Filter 65 estimator unit 61 in more detail. Such a Kalman Filter includes a state buffer 62, which stores past vector states applied as spatial beam patterns. Then a first prediction 63 is made based on the states in the state buffer 62. In parallel, a measurement 64 of the state is obtained by the decoding of the second laser signals R1-R3 as described above. Then, the Kalman Filter 65 is applied, which considers both, the most recent measurement 64 and the prediction 63 in a commonly known manner. The Kalman Filter 65 then outputs an updated prediction 66 to be applied as a first/second spatial pattern of corresponding first/second laser signals of an outgoing first/second laser beam.

At the start of the communication session, an initial state vector for the first a first optical terminal 1a is initialized to a standard configuration, which for example could be a configuration in which the phased array produces a simple Gaussian beam as the initial first spatial beam pattern. The state vector may contain all the parameters of the amplitude modulators 221, 271 and phase-shifters 222, 272, which are contained in the encoding unit 22, the quantum encoding unit 27 and decoding unit 51.

Applied to the above described embodiments, this would mean that a first optical terminal 1a sends the modulated beam B1 to a second optical terminal 1b. One of the classical communication channels is used to transmit the applied beam spatial pattern as a state vector including amplitude and/or phase information (preferably both). The second optical terminal 1b measures the power received by each of its phased-array antennas, and also retrieves from the data-stream the initial configuration of the phased array of the first optical terminal 1a. The second optical terminal 1b thus knows both what spatial beam pattern it received and what spatial beam pattern the first optical terminal 1a has sent. The second optical terminal 1b then may make a first numerical estimation of the eigenmode of the atmospheric channel 4 by the procedure shown in FIG. 7.

The phased-array as radiator unit 31 is configured accordingly and send back the second optical beam B2 to the first optical terminal 1a. The returned second optical beam B2 thus includes the phased array configuration of the second optical terminal 1b as part of the data-stream as it is modulated onto the second optical beam B2 by classical modulation schemes. As the first messages are exchanged, each of the first and second terminals 1a, 1b will keep a history of their state, and in some embodiments even the state of the partner, and use the time-series to predict the behavior of the turbulent channel in the next time step, which may be the next 10-100 ms). Depending on the atmospheric channel 4, its atmospheric turbulence, while appearing chaotic, may exhibit temporal coherence for a certain time, for example several milliseconds. The prediction of the next time steps could be made, for example, using a neural network. Following an approach inspired by Kalman filters, the terminal will then combine its prediction together with the most recent measurements of the turbulent atmospheric channel 4. This step considers the uncertainties of the prediction and of the new measurements, and gives more weight to the most accurate of the two. The updated prediction is then used to configure the phased array.

FIG. 9 shows a diagram of a prediction of a state vector made by an estimator unit of a controller of an optical terminal according to a further embodiment of the invention.

The diagram plots the state vector of the estimated beam pattern, which is addressed in the encoding units, on the y-axis 90 against the time on the x-axis.

For simplicity, only one parameter is plotted here, but in real application, the state vector is an array with several values. The predicted 92 and measured states 94 including corresponding uncertainties 93, 95 are shown in the diagram of FIG. 7. Ideally, the predicted states 92 and measured states 94 will track the configuration parameters of the phased array which best approximate the eigenvalues of the atmospheric channel 4 as predicted future states 96. Depending on the application, one or several eigenmodes can be used to increase the communication bandwidth.

The Kalman-like filter approach is particularly stable because the Kalman filter 65 uses only the new measurement 64 when they are accurate enough. During the initial phase of the communication link, or after the channel has abruptly changed, the Kalman filter 65 would instead give more weight to its model. For example, it would use a Gaussian like beam profile instead of applying a noisy correction based on an imperfect measurement.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In the detailed description above, various features have been combined in one or more examples in order to improve the rigorousness of the illustration. However, it should be clear in this case that the above description is of merely illustrative but in no way restrictive nature. It serves to cover all alternatives, modifications and equivalents of the various features and exemplary embodiments. Many other examples will be immediately and directly clear to a person skilled in the art on the basis of his knowledge in the art in consideration of the above description.

The exemplary embodiments have been chosen and described in order to be able to present the principles underlying the invention and their application possibilities in practice in the best possible way. As a result, those skilled in the art can optimally modify and utilize the invention and its various exemplary embodiments with regard to the intended purpose of use. In the claims and the description, the terms “including” and “having” are used as neutral linguistic concepts for the corresponding terms “comprising”. Furthermore, use of the terms “a”, “an” and “one” shall not in principle exclude the plurality of features and components described in this way.

While at least one exemplary embodiment of the present inventions is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiments. In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1, 1a-e optical terminal
1c space borne optical terminal
1d airborne optical terminal
1e ground-based optical terminal
2 transmitting part
3 combining part
4 atmospheric channel
5 receiving part
6 controller
7 tracking part
10 frame
21 generation unit
22 encoding unit
23 laser source
24 modulator
25 quantum generation unit
26 photon source
27 quantum encoding unit
28 multiplexer
29 single photon counter
31 radiator unit
32 optical circulator
51 decoding unit
52 detection unit
53 demultiplexers
54 quantum detection unit
55 single photon counter
61 estimator unit
62 state buffer
63 prediction
64 measurement
65 Kalman Filter
66 updated prediction
71 Beam steering element (Risley prism)
72 area-sensitive detector
73 steering mirror
74 telescope
75 relay lenses
76 beam splitter
77 reflecting mirror
90 state vector (y-axis)
91 time (x-axis)
92 prediction state
93 prediction uncertainty
94 measured state
95 measurement uncertainty
96 predicted future states
221 first amplitude modulator (amplifier)
222 first phase shifter
271 second amplitude modulator (attenuator)
272 second phase shifter
311 radiation element
511 third amplitude modulator
512 third phase shifter
B1 first laser beam
B2 second laser beam
R1-R3 second laser signals
Rc1-Rc3 second classical laser signals
Rq1-Rq3 second quantum signals
S1-S3 first laser signals
Sc1-Sc3 first classical laser signals
Sq1-Sq3 first quantum signals

Claimed is:

1. An optical terminal for free-space optical communication comprising:
a transmitting part configured to generate a plurality of first laser signals, wherein a phase, an amplitude, or both of each of the plurality of first laser signals are encoded for forming a first laser beam according to an initial first spatial beam pattern by coherently combining;
a beam combining part configured to form the first laser beam by coherently combining the plurality of first laser signals, to transmit the first laser beam towards a target through an atmospheric channel, to receive a second laser beam having an altered second spatial beam pattern, and to spatially divide the second laser beam into a plurality of second laser signals;
a receiving part configured to detect a phase, or an amplitude, or both of the plurality of second laser signals for determining the altered second spatial beam pattern; and
a controller connected to the transmitting part, the receiving part, and the beam combining part, the controller configured to
determine the altered second spatial beam pattern by analyzing the plurality of second laser signals,
estimate, by an estimator unit of the controller, a first spatial beam pattern to be applied to the first laser beam as an estimated eigenmode of the atmospheric channel based on the altered second spatial beam pattern, and
control the beam combining part for forming the first laser beam according to the estimated first spatial beam pattern.

2. The optical terminal according to claim 1, wherein the estimator unit is configured to estimate the first spatial beam pattern based on the altered second spatial beam pattern and historical data used in a probability matrix scheme.

3. The optical terminal according to claim 2, wherein the estimator unit preferably includes a Kalman Filter.

4. The optical terminal according to claim 1, wherein the transmitting part includes a generation unit for generating a plurality of laser signals and an encoding unit for encoding the plurality of laser signals for coherently combining to form a first laser beam according to a first spatial beam pattern.

5. The optical terminal according to claim 4, wherein the encoding unit includes a plurality of first amplitude modulators, or includes a first plurality of phase shifters for encoding the amplitude, the phase or both of the plurality of first laser signals, or includes both.

6. The optical terminal according to claim 4, wherein the generation unit is configured to modulate each of the plurality of first laser signals, and
wherein the controller is further configured to the generation unit to modulate the plurality of first laser signals according to the first spatial beam pattern.

7. The optical terminal according to claim 1, wherein the receiving part comprises a decoding unit for decoding the plurality of second laser signals according to an estimated second spatial beam pattern and provide a plurality of decoded second laser beam signals, and a detection unit configured to detect the plurality of decoded second laser beam signals to provide corresponding electric signals.

8. The optical terminal according to claim 7, wherein the decoding unit comprises a plurality of third amplitude modulators, or includes a plurality of third phase shifter for decoding the amplitude, the phase, or both of the plurality of second laser signals, or includes both.

9. The optical terminal according to claim 7, wherein the detection unit is configured to demodulate the second laser beam to obtain received data about an initial second spatial beam pattern, and
wherein the controller is configured to determine the first spatial beam pattern based on the initial second spatial beam pattern.

10. The optical terminal according to claim 1, wherein the beam combining part includes a radiator unit configured to form the first laser beam by coherently combining the plurality of first laser signals and spatially divide the second laser beam into a plurality of second laser signals.

11. The optical terminal according to claim 10, wherein the beam combining part comprises a plurality of optical circulator configured to direct the plurality of first laser signals from the transmitting part to the radiator unit and direct the plurality of second laser signals from the radiator unit towards the receiving part.

12. The optical terminal according to claim 10, wherein the radiator unit includes a phased array comprising a plurality of radiation elements arranged on a radiation plane.

13. The optical terminal according to claim 12, wherein the plurality of radiation elements are arranged randomly on the radiation plane.

14. The optical terminal according to claim 1, wherein the first laser beam comprises a first classical laser beam and a first quantum laser beam,
wherein the second laser beam comprises a second classical laser beam and a second quantum laser beam,
wherein the plurality of first laser signals comprises a plurality of first classical laser signals and a plurality of first quantum signals, and
wherein the plurality of second laser signals comprises a plurality of second classical laser signals and a plurality of second quantum signals.

15. The optical terminal according to claim 14, wherein the transmitting part includes a quantum generation unit comprising a plurality of photon sources configured to emit the plurality of first quantum signals, and
wherein the transmitting part includes a quantum encoding unit configured to encode the plurality of first quantum signals for forming the first quantum laser beam according to a first spatial beam pattern by coherent combining.

16. The optical terminal according to claim 15, wherein the quantum encoding unit comprises a plurality of second amplitude modulators, or comprises a plurality of second phase shifter for encoding the amplitude, or the phase, or both of the first quantum laser signal, or comprises both.

17. The optical terminal according to claim 14, wherein the transmitting part comprises a plurality of multiplexers configured to overlay the plurality of first classical laser signals with the plurality of first quantum signals, and
wherein the receiving part comprises a plurality of demultiplexers configured to separate the second classical laser signals from the second quantum signals.

18. The optical terminal according to claim 14, wherein the receiving part comprises a quantum detection unit configured to detect the plurality of second quantum signals by a corresponding amount of single photon counters.

19. The optical terminal according to claim 1, further comprising:
a tracking part configured to steer the first laser beam towards a target,
wherein the tracking part includes at least one optical beam steering element.

20. The optical terminal according to claim 19, wherein the beam steering element is configured as a flat steering element.
